(19) United States
(12) Patent Application Publication
(10) Pub. No.: US 2017/0297192 A1
(43) Pub. Date: Oct. 19, 2017

(54) TOOL HANDLE

(71) Applicant: Yu-Hua OU, Taichung City (TW)

(72) Inventor: Yu-Hua OU, Taichung City (TW)

(21) Appl. No.: 15/637,354

(22) Filed: Jun. 29, 2017

Related U.S. Application Data
(63) Continuation-in-part of application No. 14/570,729, filed on Dec. 15, 2014.

(51) Int. Cl. B25G 1/10; B25B 23/16

(52) U.S. Cl. CPC B25G 1/102; B25B 23/16; B25G 1/10

(57) ABSTRACT

A tool handle is provided for a tool rod to insert therein. A connecting end of the tool rod is formed with a mark portion. The tool handle includes a grip body, a cover layer and a perspective layer. The grip body is disposed around the connecting end and includes a window portion corresponding to the mark portion. The cover layer partially covers the grip body and exposes the window portion. The cover layer is softer than the grip body. The perspective layer is disposed on the window portion and includes at least one magnifying lens portion corresponding to the mark portion.

### BACKGROUND OF THE INVENTION

### Field of the Invention

The present invention is a CIP of application Ser. No. 14/570729, filed Dec. 15, 2014, the entire contents of which are hereby incorporated by reference.

### Description of the Prior Art

Because of growth of mechanical industry, hand tools applying for different components are becoming more. The hand tool is usually formed with a mark portion. The mark portion is usually processed by printing or pasting, and a logo or criteria of the hand tool can be displayed.

Nevertheless, though the hand tool is formed with the mark portion on a surface, a graphic of the mark portion is usually worn down by hands after using in a long time, and the mark portion is indistinct. Besides, in order to save cost, the tool handle is usually injected and formed by only one material, and the grip is integrally solid. It is uncomfortable for a user to use in a long time.

U.S. 20030211900 discloses that frictional fit or frictional coupling of the grip on the shaft is such that the insert is fully enveloped and firmly engaged within the grip, and typically in a snug pressing contact with the club shaft, as forced by the bore walls or portions thereof, so as to be secure in the grip and unable to move. There requires an additional member (the insert), thus being hard to fabricate and costly. Besides, there is no gap between the insert and the grip. It is noted that the insert with pattern is opposite to the flat portion of the grip for avoiding deformation of the pattern, while the convex portion of the grip is provided for comfort gripping but not for magnifying the pattern on the insert.

U.S. Pat. No. 5,740,586 discloses only a connecting end with a flat surface encompassed by the grip. No pattern is integrally provided on the flat surface, and no magnifying lens portion is provided on the grip.

U.S. Pat. No. 4,195,837 discloses that a cover disposed opposite to the distal end face without any pattern provided thereon. It is noted that the cover is opposite to a concave lens which can minify the pattern on the cover.

U.S. Pat. No. 5,390,572 discloses that only a hard core and a soft cushion grip. No pattern which is different from the connecting end in radial cross-sectional shape is disposed on the circumferential surface of the connecting end.

The present invention has arisen to mitigate and/or obviate the afore-described disadvantages.

### SUMMARY OF THE INVENTION

The primary object of the present invention is to provide a tool handle. The tool handle is disposed around a tool rod formed with a mark portion and includes a window portion so that a user can see an inside of the tool handle from outside. The mark portion is untouched by the user, and the mark portion is hard to wear down. Besides, the window portion is provided with a magnifying lens portion so that the mark portion is enlarged, and the tool handle is easy to be identified.

Furthermore, the tool handle is covered by a soft cover layer. The tool handle is fit to hands and it is comfortable for the user to use.

To achieve the above object, a tool handle in accordance with present invention is provided, for a tool rod to insert therein. A connecting end of the tool rod is formed with a mark portion. The tool handle includes a grip body, a cover layer and a perspective layer. The grip body is disposed around the connecting end and includes a window portion corresponding to the mark portion. The cover layer partially covers the grip body and exposes the window portion. The cover layer is softer than the grip body. The perspective layer is disposed on the window portion and includes at least one magnifying lens portion corresponding to the mark portion.

### BRIEF DESCRIPTION OF THE DRAWINGS

FIGS. 1-2 are three-dimensional drawings of a preferable embodiment of the present invention;

FIG. 3 is a breakdown drawing of the preferable embodiment of the present invention;

FIG. 4 is a perspective drawing of the preferable embodiment of the present invention;

FIG. 5 is a cross-sectional drawing of the preferable embodiment of the present invention;

FIG. 6 is a partial cross-sectional drawing of the preferable embodiment of the present invention;

FIG. 7 is a partial cross-sectional drawing of another preferable embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

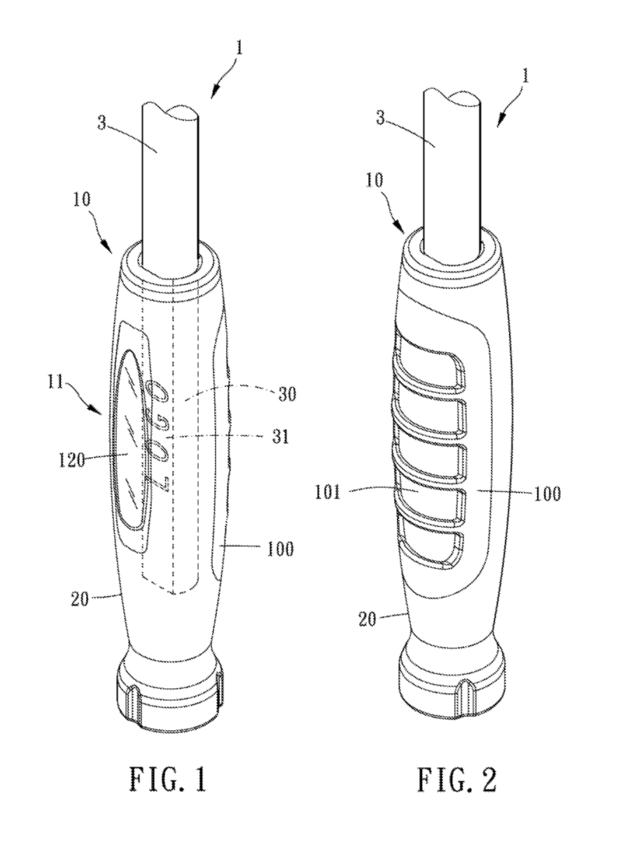

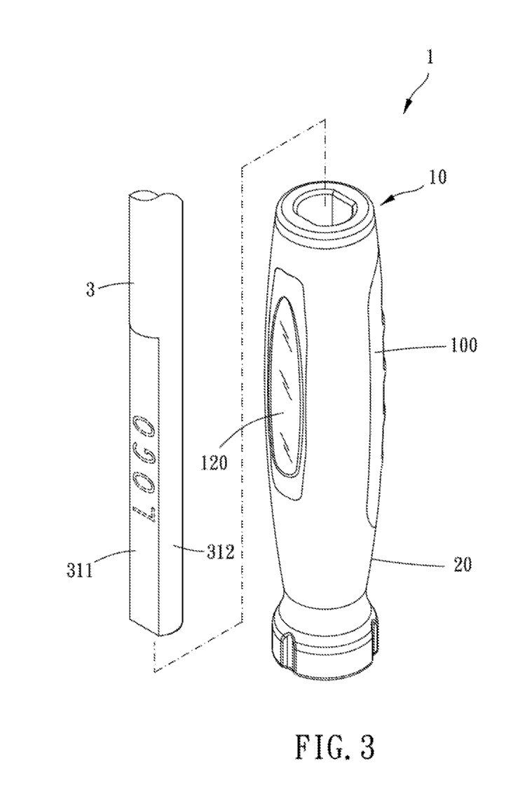

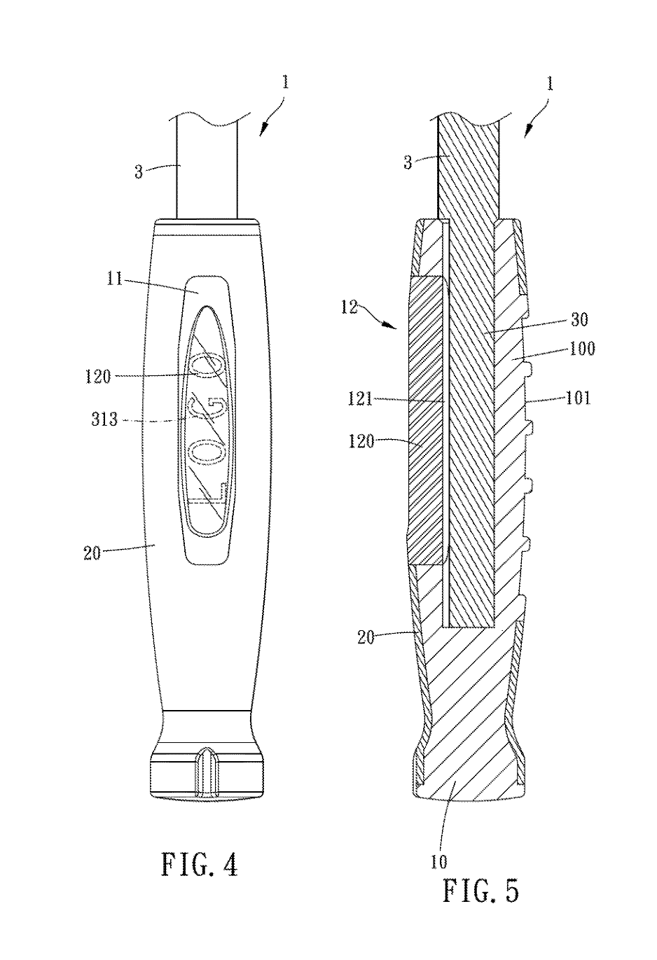

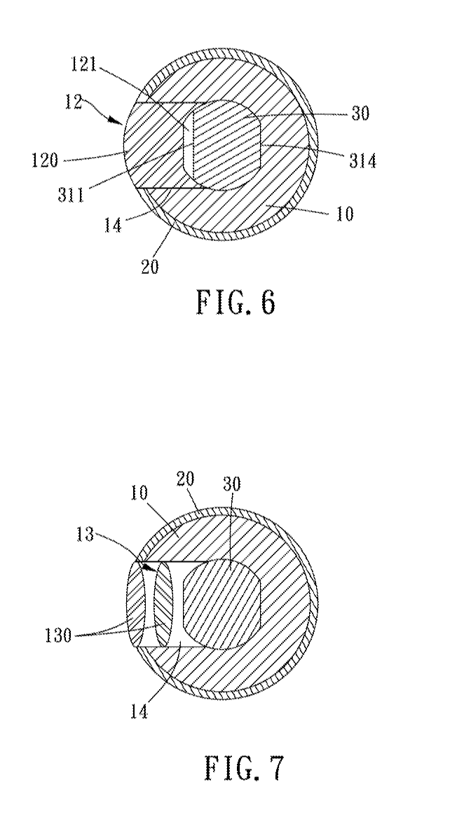

Please refer to FIGS. 1-6, a tool handle 1 in accordance with a preferable embodiment of the present invention is provided for a tool rod 3 to insert therein. A connecting end 30 of the tool rod 3 is formed with a mark portion 31. The tool handle 1 includes a grip body 10, a cover layer 20 and a perspective layer 12. In the present embodiment, the mark portion 31 of the connecting end 30 is a flat surface so that the mark portion 31 is assembled with the tool rod 3 fitly and printed easily. Moreover, a cross section of the connecting end 30 can be circular, rectangular or can have other shapes. The connecting end 30 is integrally formed as a part of a tool rod 3. The mark portion 31 is integrally formed as a part of the connecting end 30, the mark portion 31 is a flat surface 311 which extends on a circumferential surface 312 of the connecting end 30 and has a pattern 313 being different from the connecting end 30 in radial cross-sectional shape, and the pattern 313 is integrally formed as a part of the mark portion 31. The connecting end 30 further includes a flat face 314 opposite to the flat surface 311.

The pattern 313 may be integrally protrusive on the mark portion 31, integrally recessed on the mark portion 31, a region of the mark portion 31 which is roughed, a region of the mark portion 31 which is polished, or formed by differences of roughness on the mark portion 31.

The grip body 10 is disposed around the connecting end 30 and includes a window portion 11 corresponding to the mark portion 31. The mark portion 31 is seen through the window portion 11. Moreover, the perspective layer 12 is disposed on the window portion 11 and includes at least one magnifying lens portion 120 corresponding to the mark portion 31, and a graphic of the mark portion 31 is enlarged. In the present embodiment, a whole of the perspective layer 12 is formed as the magnifying lens portion 120. Specifically, the grip body 10 is formed with a concave slot 14 and the perspective layer 12 is additionally engagingly disposed in the concave slot 14. It is noted that the grip body and the perspective layer can be formed integrally. Moreover, a gap 121 is formed between the mark portion 31 and the perspective layer 12, and the magnifying lens portion 120 and the pattern 313 are distanced by the gap 121 and opposite to each other. In other embodiments, the mark portion 31 and the perspective layer 12 can be abutted against each other directly. The tool rod 3 is more steadily inserted in the grip body 10.

In another embodiment, as shown in FIG. 7, a perspective layer 13 can be engagingly provided with two magnifying lens portions 130. The two magnifying lens portions 130 correspond to the mark portion 31, and the perspective layer 13 has a better result in enlarging the graphic. It is noted that the perspective layer can be engagingly provided with more magnifying lens portions, or every portion of the mark portion can respectively correspond to one said magnifying lens portion.

Please refer to FIGS. 1-6 again, the cover layer 20 partially covers the grip body 10 and exposes the window portion 11. The cover layer 20 is softer than the grip body 10. Moreover, the cover layer 20 is substantially deformed and fit to a hand when a user holds it, and it is comfortable for the user to hold and use. Preferably, the cover layer 20 can be made of ventilating material, and the user is hard to sweat in hands after a long time of using. In the present embodiment, the cover layer 20 is in a first color, and the grip body 10 is in a second color. The first color is different from the second color so that the tool handle 1 is easily identified. It is noted that the first and second colors can be the same.

In the present embodiment, the grip body 10 further includes a grip portion 100. The grip portion 100 includes a plurality of recesses 101 so that the user can hold it steadily and it is hard to slip off from the hand of the user. It is noted that the grip body can be formed without the grip portion, and the grip body 10 can be covered by a material with high friction or rough structures, and it is also stable for operating.

As a conclusion, the tool handle of the present invention is embeddingly provided with the mark portion, and the graphic of the mark portion is hard to wear down. Moreover, the tool handle is further provided with the magnifying lens portion on the window portion, and when the user sees through the magnifying lens portion, the graphic is enlarged and the tool handle is easy to be identified.

Moreover, the tool handle is covered by the soft cover layer, and it is comfortable for the user to hold and use.

Besides, the tool handle further includes the grip portion, and it is stable for the user to hold and operate and it is hard to slip off form the user.

While we have shown and described various embodiments in accordance with the present invention, it should be clear to those skilled in the art that further embodiments may be made without departing from the scope of the present invention.

What is claimed is:

1. A tool handle, comprising:
a connecting end, being integrally formed as a part of a tool rod, including
a mark portion;
a grip body, disposed around the connecting end and including a window portion corresponding to the mark portion;
a cover layer, partially covering the grip body and exposing the window portion, the cover layer softer than the grip body;
a perspective layer, disposed on the window portion, including at least one magnifying lens portion corresponding to the mark portion;
wherein the mark portion is integrally formed as a part of the connecting end, the mark portion is a flat surface which extends on a circumferential surface of the connecting end and has a pattern being different from the connecting end in radial cross-sectional shape, the pattern is integrally formed as a part of the mark portion;
wherein the grip body includes a concave slot and the perspective layer is additionally engagingly embedded in the concave slot;
wherein a gap is formed between the mark portion and the perspective layer;
wherein the magnifying lens portion and the pattern are distanced by the gap and opposite to each other.

2. The tool handle as claimed in claim 1, wherein the connecting end further includes a flat face opposite to the flat surface.

3. The tool handle as claimed in claim 1, wherein the grip body includes a grip portion, and the grip portion includes a plurality of recesses.

4. The tool handle as claimed in claim 1, wherein a whole of the perspective layer is formed as the magnifying lens portion.

5. The tool handle as claimed in claim 1, wherein the cover layer is in a first color, the grip body is in a second color, and the first color is different from the second color.

6. The tool handle as claimed in claim 1, wherein the cover layer is in a first color, the grip body is in a second color, and the first and second colors are the same.

7. The tool handle as claimed in claim 1, wherein the pattern is integrally protrusive on the mark portion.

8. The tool handle as claimed in claim 1, wherein the pattern is integrally recessed on the mark portion.

9. The tool handle as claimed in claim 1, wherein the pattern is a region of the mark portion which is roughed.

10. The tool handle as claimed in claim 1, wherein the pattern is a region of the mark portion which is polished.
